(19) United States
(12) Patent Application Publication
(10) Pub. No.: US 2026/0030615 A1
(43) Pub. Date: Jan. 29, 2026

(54) METHOD FOR TRANSMITTING DIGITAL TOKENS

(71) Applicant: DG Nexolution eG, Wiesbaden (DE)

(72) Inventors: Nikolaos STIVAKTAKIS, Wiesbaden (DE); Peter SÖHNE, Wiesbaden (DE); Nils WEIDENHAMMER, Wiesbaden (DE); Ralf NICKLAS, Wiesbaden (DE); Tilo FRITZHANNS, Wiesbaden (DE)

(21) Appl. No.: 19/278,035

(22) Filed: Jul. 23, 2025

(30) Foreign Application Priority Data
Jul. 25, 2024 (EP) 24190916.7

(51) Int. Cl. G06Q 20/36; G06Q 20/38; G06Q 20/40; H04L 9/32

(52) U.S. Cl. CPC G06Q 20/3676; G06Q 20/36; G06Q 20/3825; G06Q 20/405; H04L 9/3242

(57) ABSTRACT

A method for transmitting a digital token between digital wallets within a transaction infrastructure during an offline session, where the wallets may belong to different development generations. According to the invention, the token is assigned an attribute indicating the development generation of the wallet with the oldest development generation in which the digital token was held at least during the current offline session. A digital token is configured to be transmitted using this method, along with a digital wallet configured for this purpose and a transaction infrastructure.

### BACKGROUND

The present invention relates to a method for transmitting digital tokens between digital wallets of a transaction infrastructure during an offline session. The invention further relates to such digital tokens and wallets and a corresponding transaction infrastructure.

Digital payment systems are generally online, i.e. their elements and participants are in data communication with each other via a suitable digital transaction or data communication infrastructure. In this state, units of value or money can be transmitted between different electronic wallets or purses using suitably standardized data communication, for example to make payments.

Such units of value or money or wallets are usually referred to as digital tokens or digital wallets. These terms are often used in connection with cryptocurrencies and blockchain or distributed ledger networks. Accordingly, a token represents a digital unit or a digital asset that is stored in a digital wallet. The transmission of tokens and their storage in wallets is cryptographically secured, particularly in the context of an offline session, for example by means of asymmetric encryption (public/private key infrastructure), cryptographic signatures or similar.

In the context of the present invention, the terms token and wallet are not limited to blockchain or distributed ledger technologies but also relate to digital payment systems and their transaction infrastructure based on other technologies, for example also to technical solutions discussed under the term “Central Bank Digital Currency” (CBDC).

Accordingly, these terms also include account-based approaches and systems in which no units of value are transmitted in the technical sense, but in which the account balance of the sending wallet (the payer) is reduced and the account balance of the receiving wallet (the payee) is increased accordingly during a payment transaction. The concepts “token” and “transmission of tokens” are therefore to be understood in the context of the present invention in such a way that the value units in such wallets are also referred to as tokens and the described process of balancing account balances is therefore also referred to as the transmission of tokens.

Wallets can be implemented as software and hardware wallets, with the latter being preferred for reasons of data and transaction security. Hardware wallets are usually implemented in the form of or within security elements. A security element comprises a special microprocessor chip with security features that protect sensitive data stored in the microprocessor chip, such as tokens, cryptographic keys or other cryptographic material. They are usually realized as chip cards, smart cards or microprocessor cards or are part of a mobile device, such as a cell phone or other portable telecommunications terminal. Security elements are particularly protected against physical attacks.

It is evident that such security elements and their wallets are occasionally or even regularly offline, i.e. they are at least temporarily disconnected from the digital payment system in question and cannot enter into data communication with other wallets or with any central entity that may be present via the associated transaction infrastructure. Wallets that are not connected to the transaction infrastructure are sometimes referred to as cold wallets, while wallets that are connected to the relevant transaction or data communication infrastructure, i.e. that are online, are referred to as hot wallets.

In the context of token-based payment systems, the double-spending problem must be solved, which arises from the fact that units of value or money are no longer exclusively physical and therefore uniquely identifiable, but in the form of digital representations, i.e. the tokens, and can therefore in principle be copied at will.

The solutions to the double-spending problem generally involve the validation of payment transactions, i.e. the transmission of tokens between two hot wallets, by the transaction infrastructure. This involves ensuring online that a token to be transmitted has not yet been transmitted. However, even in offline situations or during offline sessions, the transmission of tokens between two cold wallets must ultimately be validated in order to prevent multiple use (“double spending”) of tokens.

Within an offline situation or during an offline session, it is currently only possible to exclude the manipulation of stored tokens in the security element, provided the security element is not compromised. However, the older the security element is, i.e. the lower the development version or generation of the security element is, the more susceptible to compromise and manipulation is the security element, and the wallets set up on it. Since the cryptographic processes used for transaction security are constantly improving, i.e. keeping pace with the evolving attacks, for example for algorithmic reasons or due to increasing key lengths, it can be assumed that the risk of manipulation increases with the age of the development generation of a wallet.

It is therefore conceivable that tokens are duplicated offline or otherwise manipulated in wallets of a sufficiently old development generation, which are then accepted by wallets of younger development generations and used online. This results in a conceivable attack in which an attacker transmits manipulated or duplicated tokens in a cascade via a series of wallets of the next younger development generation and finally deposits them in a wallet of the latest (current) development generation. As a result, the manipulation would no longer be recognizable, and the manipulated or duplicated tokens could be used online at will.

Against this background, it is the problem of the present invention to overcome the problems described and to secure the transmission of tokens between digital wallets during an offline session.

### SUMMARY

In the context of the present invention, the development generation of a wallet is to be understood as a stable version or a technological development stage of the wallet software and/or the software/hardware of a security element on which the wallet is set up. Older development generations were therefore developed earlier and are less advanced technically, in particular in terms of security, while more recent development generations were developed later and are more advanced technically, in particular in terms of security.

The wallets used as part of a transaction infrastructure generally belong to very different development generations. This means that wallets of one development generation must transact with wallets of both younger and older development generations so that the transaction infrastructure offers the functionality expected by the user and the overall system.

According to a first aspect of the invention, the invention relates to a method for transmitting a digital token between digital wallets of a transaction infrastructure during an offline session, wherein the digital wallets may belong to different development generations. The two wallets involved in the token transmission are hereinafter referred to as the sending wallet and the receiving wallet.

According to the invention, the token is assigned an attribute that represents the development generation of the wallet with the oldest development generation in which the digital token was held at least during the current offline session.

The wallets of the current offline session are to be understood as the series of those wallets in which the token attributed according to the invention has been held since it was available offline, whereby the respective sending wallet is the last wallet in this series and the respective receiving wallet does not (yet) belong to this series. According to the invention, the attribute of the transmitted token thus represents the oldest development generation of at least all wallets in this series.

When the first token transmission of the offline session takes place, this series consists only of the sending wallet. According to the invention, the attribute of the transmitted token then represents the development generation of the sending wallet. If the initially receiving wallet in turn transmits or has transmitted the token to a further, third wallet, the attribute represents the development generation of the older of the two originally sending and receiving wallets.

As the attribute always indicates the oldest development generation visited by a token in this way, the risk of manipulation to which it was exposed during the current offline session can be estimated. The older the development generation represented by the attribute, the greater the risks to which the token in question was exposed during the offline session. The attribute according to the invention therefore makes it possible to determine the risk of each individual token that it may have been manipulated or falsified during the current offline session.

By using the attribute to accept or reject transactions or token transmissions, the transmission of tokens between digital wallets during an offline session is secured. The older the development generation represented by the attribute, the more likely it is that the transmission of this token will be rejected for security reasons. For this reason, a receiving wallet only accepts a token from a sending wallet if the token in question or its attribute meets a specified criterion that sufficiently minimizes the risk that the token to be transmitted has been forged or manipulated. Otherwise, the token is rejected.

If, for example, an attacker was able to manipulate or duplicate a token while it was in a wallet with a comparatively old development generation, checking the attribute prevents the manipulated or duplicated token from entering a wallet of a young (current) development generation and then being used online without restriction.

The attribute can be an inherent feature of each token, or it can only be created or activated when the token in question is transmitted offline for the first time during an offline session.

Preferably, the attribute is updated in connection with the transmission of the token during the offline session. This update involves checking whether the development generation of the sending wallet is older than the development generation that the attribute currently represents. If this is the case, the attribute is updated by assigning it the development generation of the sending wallet, as this is then the oldest development generation of all wallets in which the transmitted token was held during the current offline session.

In other words, if the development generation represented by the attribute of the transmitted token is younger than the development generation of the sending wallet, the attribute is updated. If the development generation represented by the attribute of the transmitted token is older than the development generation of the sending wallet, the attribute remains unchanged.

The attribute can be updated either by the wallet that sends the relevant token or by the wallet that receives the relevant token. The receiving wallet must know the development generation of the sending wallet.

It can happen that a token is transmitted to a number of wallets in succession during an offline session. In such cascading transactions, which can be used to conceal a manipulation or an attack, the attribute of the token is updated by each receiving wallet in such a way that it represents the oldest development generation within this plurality of wallets.

The updated attribute according to the invention is then used to determine whether the receiving wallet can accept the transmitted token. For example, the transmitted token is rejected by the receiving wallet if the development generation that its attribute represents fulfills a predefined exclusion criterion. In this respect, the attribute is preferably updated first and then the acceptance check takes place, preferably in the receiving wallet during the offline session. If the acceptance check shows that the exclusion criterion is met, the token in question is rejected and remains in the sending wallet.

Tokens that are rejected due to this acceptance check are preferably validated as soon as the offline session is ended, i.e. when the wallet is reconnected to the transaction infrastructure. The validation checks whether the token in question was actually manipulated or duplicated during the offline session or at least whether there is a sufficiently high probability of manipulation or duplication.

The receiving wallet preferably accepts the transmitted token based on a comparison of the development generation that the attribute of the token represents with the development generation of the receiving wallet. As part of such a comparison, the token is preferably accepted by the receiving wallet during the offline session if the following inequality is satisfied: A*>(G−T). Here, A* denotes the development generation that the attribute of the transmitted token represents after it has been updated so that the development generation of the sending wallet is also taken into account in the acceptance check. Furthermore, G denotes the development generation of the receiving wallet and T is a predefined security parameter that defines the interval of generations within which the development generation represented by the attribute must lie for the token in question to be accepted. If the inequality is not satisfied, i.e. if A*≤(G−T) applies, the transmitted token is not accepted by the receiving wallet and is rejected.

Preferably, tokens that are not accepted by receiving wallets are transmitted to an intermediary and/or a central entity for validation and/or renewal after the offline session has ended.

During an offline session, it may happen that a wallet does not accept a token that is to be transmitted to it. This token is then marked and/or stored separately during the offline session and can then no longer be used for transactions or transmitted to other wallets. Therefore, tokens that are not accepted or rejected by a receiving wallet are marked and/or stored separately in the respective sending wallet. As soon as a wallet ends the offline session by reconnecting to the transaction infrastructure, these unaccepted and marked/stored tokens can be validated centrally, for example by a central entity of the transaction infrastructure set up for this purpose or by an intermediary. Suitable intermediaries in this context would be, for example, the operating organizations of the wallets, national central banks or suitable executive bodies or authorities.

The validation process checks whether the unaccepted token in question is nevertheless valid, i.e. whether it represents a genuine monetary unit and has not been manipulated or duplicated in an attack on a wallet. In the former case, the token can be renewed and made available to the wallet for transactions again, for example by updating the development generation of the attribute appropriately. In the latter case, the token can be categorized as counterfeit and withdrawn from circulation.

Preferably, the wallets, their transactions, the tokens and the attributes are cryptographically secured. The attributes can be protected against forgery using electronic signatures, for example. For this purpose, each wallet has an individual private signature key pWallet and the corresponding public verification key. The signature key is signed with a universal signature key pG of the issuer and thus unalterably assigned to the development generation G. Every message that is signed by the wallet in question with the signature key pWallet thus serves as proof of the wallet's development generation G.

To cryptographically secure the transactions, a challenge-response protocol can be carried out when the session is initiated, whereby the random parameters (“nonces”) transmitted in the process are used to MAC-secure messages to be exchanged during the session. In this way, each wallet proves that it has and can use the appropriate cryptographic keys for the generation.

In principle, the tokens are either indivisible, or they can be split and merged with other tokens to form a new token.

Indivisible tokens each have a fixed, unchangeable value like cash. Such tokens can come in different denominations, such as 1, 2, 5, 10, 50 Eurocents or 1, 2, 5, 10, 20, 50, 100 or 500 Euros. Tokens can also have denominations that do not correspond to a cash denomination, such as EUR 200, 2,000, 5,000 or 10,000. Alternatively, only tokens of the smallest denomination can be provided, such as 1 Eurocent. Each amount is then realized in a wallet as a quantity of individual, indivisible 1-Eurocent tokens.

Each indivisible token has the attribute according to the invention. When transmitting a monetary value that must be represented by several indivisible tokens, for example 15 Euros are realized by two tokens of 10 Euros and 5 Euros each, it may happen that one of the several tokens is not accepted by the receiving wallet. In this case, the unaccepted token is preferably marked or stored accordingly in the sending wallet. If necessary, either the entire transaction is then reversed, or the missing amount is subsequently requested or only the amount of money that the accepted tokens represent in total is transmitted and posted.

In the case of a divisible token, its attribute is preferably passed on unchanged to the tokens divided from it. If a divisible token with a value of EUR 12.45 and the attribute A=G is divided into two tokens of EUR 10.00 and EUR 2.45 in the course of a transaction, the two resulting tokens also have the attribute A=G. When two tokens are merged, the attribute of the resulting token is assigned the older of the two development generations for security reasons. When merging two tokens whose attributes represent the development generations G1 and G2>G1, the attribute A of the merged token represents the older development generation A=G1.

Preferably, the integrity of the transmission of the digital token is secured by a message authentication code (MAC). For this purpose, the MAC is generated by deriving a cryptographic hash value from the token, its value and its attribute and encrypting it with a secret key. The MAC serves as a kind of “seal of origin” for the token and can be checked for authenticity by the receiving wallet because it has the same secret key (symmetric encryption) or a corresponding public key (asymmetric encryption).

In connection with an account-based embodiment of the invention, when a token is transmitted, an account balance in the sending wallet is reduced by the monetary value to be transmitted and an account balance in the receiving wallet is increased accordingly. In this embodiment, attributes are not realized as data elements that are linked to the tokens and are transmitted together with them, but sub-wallets or sub-wallets are created in the wallets, each representing the possible development generations. The sum of the sub-account balances of all sub-wallets of a wallet then corresponds to the account balance of this wallet. When tokens are transmitted, the sub-account balances of those sub-wallets in which the sub-account balances were reduced in the sending wallet are increased in the receiving wallet with exactly the same development generation.

In the account-based embodiment variant, too, the receiving wallet preferably either accepts or rejects a token to be transmitted based on a comparison of the development generation representing the updated attribute of the token with the development generation of the receiving wallet. The token is therefore preferably accepted by the receiving wallet during the offline session if the following inequality is fulfilled: A*>(G−T). If the inequality is not fulfilled, i.e. if A*≤(G−T) applies, the transmitted token is rejected by the receiving wallet and remains in the sending wallet.

According to a second aspect of the invention, the invention relates to a digital token which is set up according to the invention for transmission between digital wallets of a transaction infrastructure during an offline session, wherein the wallets may belong to different development generations. According to the invention, the wallet is assigned an attribute that represents the development generation of the wallet with the oldest development generation in which the digital token was held at least during the current offline session.

Preferably, the token is arranged to be transmitted during an offline session according to the methods and embodiments according to the first aspect of the invention.

According to a third aspect of the invention, the invention relates to a digital wallet of a transaction infrastructure which is set up for transmitting digital tokens according to the second aspect during an offline session. The digital wallet is set up in such a way that it supports the methods according to the first aspect. Here, the attribute of a token transmitted to a receiving wallet is updated to the development generation of the sending wallet if the development generation representing the attribute is younger than the development generation of the sending wallet.

According to a fourth aspect of the invention, the invention relates to a digital transaction infrastructure comprising a plurality of digital wallets according to the third aspect of the invention and digital tokens according to the second aspect of the invention. The transaction infrastructure is arranged to support offline sessions according to the invention.

The digital transaction infrastructure according to the invention preferably comprises, in particular, a validation unit which validates and/or renews tokens online which were not accepted or were rejected during an offline session.

### BRIEF DESCRIPTION OF THE DRAWINGS

Further advantages, features and details of the invention are shown in the following description of the attached figures. The description of the figures is not to be understood as limiting, as it explains individual preferred embodiments of the invention, the features of which can be combined with one another and with the features described above. The figures show:

FIG. 1 an illustration of a transaction infrastructure according to the invention;

FIG. 1a a variant of the embodiment according to FIG. 1;

FIG. 2 a flowchart showing the steps of the method according to the invention;

FIG. 2a a variant of the embodiment according to FIG. 2;

FIG. 3 a process for splitting and/or assembling a token during an offline session; and

FIG. 4 an illustration of a wallet according to an account-based approach.

### DETAILED DESCRIPTION OF THE INVENTION

In the following, the present invention will be explained in detail with reference to the attached figures. The figures disclose specific embodiments and variants of the present invention. These embodiments and variants of the invention are described in sufficient detail to enable the person skilled in the art to implement the invention. It is understood that the various embodiments are not mutually exclusive, although they may differ from one another. For example, a particular feature or structure described herein in connection with one embodiment may also be implemented in other embodiments without departing from the scope of the present invention. It is equally self-evident that the position or arrangement of individual features or elements within a disclosed embodiment can be modified without departing from the scope of the present invention.

The following detailed description of the figures is therefore not to be understood in a restrictive sense. The scope of the present invention is defined solely by the appended claims in the light of a technically reasonable interpretation and taking into account any equivalents. In the figures, identical reference signs refer to identical or functionally equivalent features or elements in different embodiments.

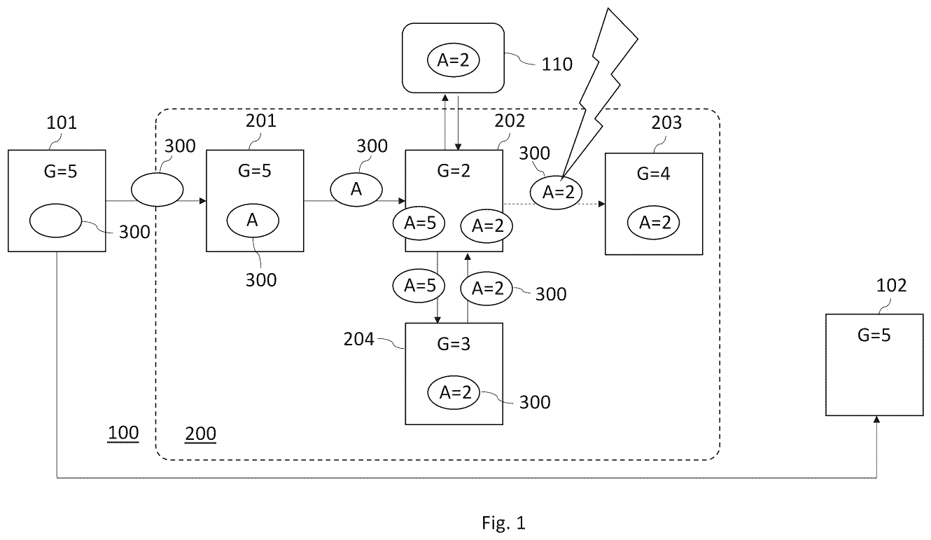

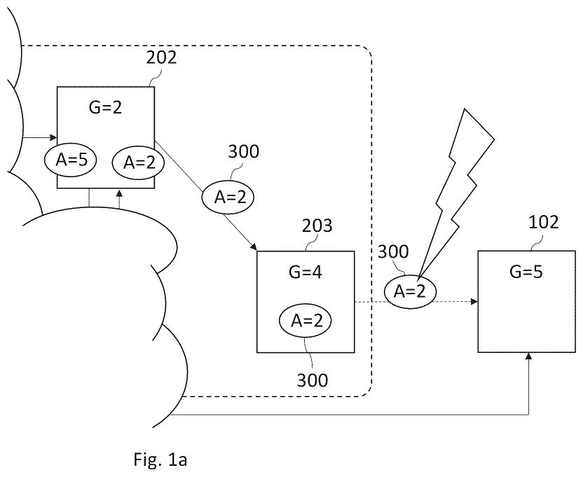

FIG. 1 illustrates a transaction infrastructure for the transmission of units of money or value. Known examples of such a transaction infrastructure are the Bitcoin network and blockchain or distributed ledger networks for handling cryptocurrencies and transmitting Bitcoin and other crypto tokens. Central bank digital currencies (“CBDC”) currently under development worldwide are also based on transaction infrastructures in the context of which the present invention is applicable. This includes, in particular, the infrastructure of the future digital Euro of the European Central Bank.

Just like such exemplary transaction infrastructures, the transaction infrastructure according to the invention also comprises digital end devices with digital wallets, such as cell phones, computers or specialized hardware wallets, which enable users to receive and transmission units of money or value, so-called tokens, as part of transactions.

The transaction infrastructure also includes or uses a data communication network that enables data communication between the end devices or their wallets and to and from central processing units, such as an intermediary or a central entity. In the simplest case, the Internet functions as the data communication network of the transaction infrastructure. Finally, the transaction infrastructure is equipped with security systems and functions that ensure the integrity and protection of transactions and monetary/value units or tokens through cryptographic processes such as encryption and decryption or signing and verification.

A wallet is essentially an executable software structure, such as an installed app, which enables the storage and protection of monetary/value units or tokens. As a rule, a wallet also includes a suitable user interface that is shown on the display of the digital end device on which it is installed.

For security reasons, wallets are often designed as hardware wallets and installed in secure elements, such as smart cards, SIM mobile phone cards, TPM chips or similar. These special microprocessor chips are equipped with security functions to protect sensitive data, such as cryptographic material, in isolation from the actual end device. In particular, security elements also protect against physical attacks and tampering.

FIG. 1 shows wallets 101, 102, 201-204 and a token 300, which is transmitted step by step from and to the aforementioned wallets 101, 102, 201-204. A distinction is made between the offline session 200 and the online session 100. The wallets 101, 102 and the intermediary 110 are online, i.e. connected to the transaction infrastructure. The intermediary 110 is operated by the issuer of the token 300 or a trustworthy institution, such as the European Central Bank or another suitable authority.

The wallets 201-204 are separate from the transaction infrastructure and therefore offline. During the online session 100, the components of the transaction infrastructure are interconnected and real-time transactions are performed, for example as indicated by the arrow between the wallets 101, 102.

FIG. 1 shows how the exemplary token 300 is first transmitted from the wallet 101 to the wallet 201 during the online session 100. The wallet 201 then goes offline and the offline session 200 begins. The authenticity of the token 300 is not questioned during this first transaction, as its authenticity has been checked online.

During the offline session 200, the token 300 is transmitted from the wallet 201 to the wallets 202, 203, 204 one after the other. None of the wallets 201, 202, 203, 204 is connected to the transaction infrastructure during this time, so that the token 300 is transmitted by directly linking two of the wallets 201, 202, 203, 204, for example via USB or NFC interfaces.

Each wallet 101, 102, 201-204 originates from a specific development generation G. Each wallet 101, 102, 201-204 “knows” its own development generation, because it is stored in the wallet as a data element or parameter. In the context of the embodiments described, a wallet 101, 102, 201-204 according to the invention also knows at least the development generations G of all those wallets 101, 102, 201-204 that transmit the token 300 to this wallet 101, 102, 201-204, as described in detail below.

The development generation G indicates the technological development status of the respective wallet 101, 102, 201-204, from which features and functions, security standards and updates, performance features as well as software and hardware versions and the compatibility and integration level can be derived. The smaller the development generation G of a wallet is numerically, the older and less protected it is and the more vulnerable it is to manipulation. The wallets 101, 201, 102 in FIG. 1 are the youngest and most tamper-proof wallets with development generation G=5, while the tamper-proofness of wallets 203 (G=4), 204 (G=3) and 202 (G=2) is successively worse.

Against this background, a known attack vector relates to compromising the oldest wallet 202 (G=2) during the offline session 200, for example, by forging or duplicating its tokens 300. These forged or duplicated tokens 300 are then transmitted to a current wallet of development generation G=5 via a transmission chain of ascending development generations, i.e. successively to wallets 204 (G=3), 203 (G=4) and finally 102 (G=5), as the system allows each wallet to transmission tokens 300 at least to wallets of the next higher and next lower development generation and receive them from these. This disguises the original compromise and legitimizes the counterfeit or duplicated tokens 300.

According to the example according to FIG. 1, the token 300 is in the wallet 201 when the offline session 200 starts by interrupting the connection of the wallet 201 to the transaction infrastructure. In response, the wallet 201 sets up the attribute A in the token 300 stored in it. In the same way, each wallet sets up attribute A in all its tokens when it goes offline.

Alternatively, attribute A can also be created in all tokens by default, even if attribute A is not required during an online session 100.

The token 300 is to be transmitted from the sending wallet 201 of development generation G=5 to the receiving wallet 202 of development generation G=2.

To do this, the receiving wallet 202 checks whether it can accept the token 300 at all. This is the case because during the current offline session 200 it was only stored on wallets within an acceptable interval of development generations.

During the acceptance check, the development generation G of the sending wallet 201 must be taken into account, so that the updated attribute A* of the token 300 must be used. If the attribute A is already updated by the sending wallet 201, the acceptance check can then be carried out by the receiving wallet 202. If, preferably, the attribute A is only updated by the receiving wallet 202 after its transmission, the (future) value of the attribute A after the update must be taken into account in the acceptance check. The (future) value of the updated attribute A is referred to below as A* for better understanding.

For the acceptance check in the preferred case of attribute updating only after the successful token transmission, the wallet 202 checks the inequality A*>(G−T), where T is a security parameter that defines the acceptable interval of development generations. As an example, the security parameter T=2 is assumed so that the inequality 5>(2−2) is fulfilled and the receiving wallet 202 can accept the transmitted token 300.

In order for the receiving wallet 202 to be able to perform this acceptance check, it requires the development generation G=5 of the sending wallet 201, which it reads from the sending wallet 201 or receives from it. Of course, such a readout or transmission of the development generation G of the sending wallet 201 is cryptographically secured in a similar way as the transmission of the token 300 itself. According to one embodiment, the acceptance check can also be carried out by the sending wallet 201.

After the positive acceptance check by the receiving wallet 202, the token 300 is transmitted and its attribute A is updated. It is then assigned the value A* that was already used in the acceptance check. For this purpose, the receiving wallet 202, which belongs to the development generation G=2, assigns the development generation G=5 of the sending wallet 201 to the attribute A of the token 300. Naturally, the sending wallet 201 deletes the transmitted token 300 after the successful transmission.

In the embodiment described, the security parameter T is a positive integer and determines a tolerated generation distance or an acceptable generation interval based on the development generation of the respective receiving wallet. A transmitted token is not accepted if the development generation that represents its attribute exceeds this generation distance or if it lies outside this interval. If the development generation representing an attribute does not exceed the generation distance determined by the security parameter T or if it is within the generation interval, the verifying wallet can accept the token in question and transmission it offline or online to other wallets.

The entire transaction, including the reading or sending of the development generation G=5 of the sending wallet 201 and the transmission of the token 300 to the receiving wallet 202, is cryptographically secured. For example, an initial challenge-response procedure can be carried out in order to use randomly generated parameters, so-called “nonces”, for MAC protection of the (data) transactions. In this way, each wallet proves that it has the cryptographic keys that match its own development generation.

According to FIG. 1, the token 300 (A=5) is to be further transmitted from the now sending wallet 202 (G=2) to the receiving wallet 204 (G=3). For this purpose, the value of the updated attribute A* must be determined, which the receiving wallet 204 would assign to the token 300 after a successful transmission of the token 300. Since in this case the development generation G=2 of the sending wallet 202 is older than the one that the attribute A=5 currently represents, the value of the updated attribute A* of the token 300 corresponds to the development generation G=2 of the sending wallet 202. A*=2 therefore applies.

The corresponding acceptance check using the inequality A*>(G−T) shows that the inequality is fulfilled with 2>(3−2) and the wallet 204 accepts the token 300 as a valid means of payment. After transmitting the token 300, the receiving wallet 204 updates its attribute to A=2.

The token 300 is then transmitted from the wallet 204 back to the wallet 202. When the token 300 is updated by the wallet 202, the attribute A=2 is not changed, because the development generation of the wallet 204 is younger with G=3, and the acceptance check by the wallet 202 establishes the validity of the token 300.

The token 300 is then transmitted from the wallet 202 to the wallet 203. Since the development generation of wallet 203 with G=4 is younger than the development generation that the attribute A=2 represents, the attribute A=2 of token 300 would remain unchanged during the update, so that A*=2 applies. The acceptance check now shows that the inequality A*>(G−T) is not fulfilled, because 2=4−2 applies. Consequently, token 300 with the updated attribute A*=2 is not accepted by wallet 203 of development generation G=4 because the difference between the development generations is too great. During the current offline session 200, the token 300 was already in a wallet whose development generation is too old, namely in wallet 202 (G=2), to be accepted by a wallet of development generation G=4. Because the token 200 was already present in a wallet as vulnerable to manipulation as wallet 202 (G=2), it is rejected by wallet 203 (G=4) and earmarked for validation as soon as offline session 200 has ended.

The unaccepted or rejected token 300 thus remains in the sending wallet 202 and is stored there until the wallet goes online again and validation of the token 300 becomes possible.

According to the embodiment example of FIG. 1, the update of the attribute A is carried out by the respective receiving wallet 204, 202 with recourse to the development generation G of the respective sending wallet 202, 204. Alternatively, this update can also be carried out by the sending wallet.

Finally, according to FIG. 1, the offline session 200 ends and the wallet 202 is reconnected to the transaction infrastructure. Now the unaccepted token 300 is transmitted to the intermediary 110 for validation, which checks whether the token 300 has actually been manipulated, duplicated or forged, or at least whether there is a sufficiently high probability of manipulation or duplication. If this is the case, the specific token 300 is withdrawn from circulation as in the case of counterfeit money and, if necessary, renewed or replaced. If the token 300 is recognized as valid, it is returned to the wallet 202 as a valid means of payment.

The moment a wallet is online again, the attributes A lose their meaning and can be deleted. Alternatively, attributes A can also be set to the current generation.

FIG. 1a illustrates the case of a security parameter T=3, which differs from the example in FIG. 1, in which the inequality A*>(G−T) is fulfilled due to 2>4−3 when the token 300 is transmitted from the wallet 202 to the wallet 203. In this case, wallet 203 (G=5) would accept token 300. For the subsequent transmission of the token 300 from wallet 203 to wallet 102, the inequality A*>(G−T) must then be satisfied again, as wallet 203 (G=5) is regarded as an offline wallet. In this case, however, the above inequality with 2=5-3 is not fulfilled and the transaction is rejected.

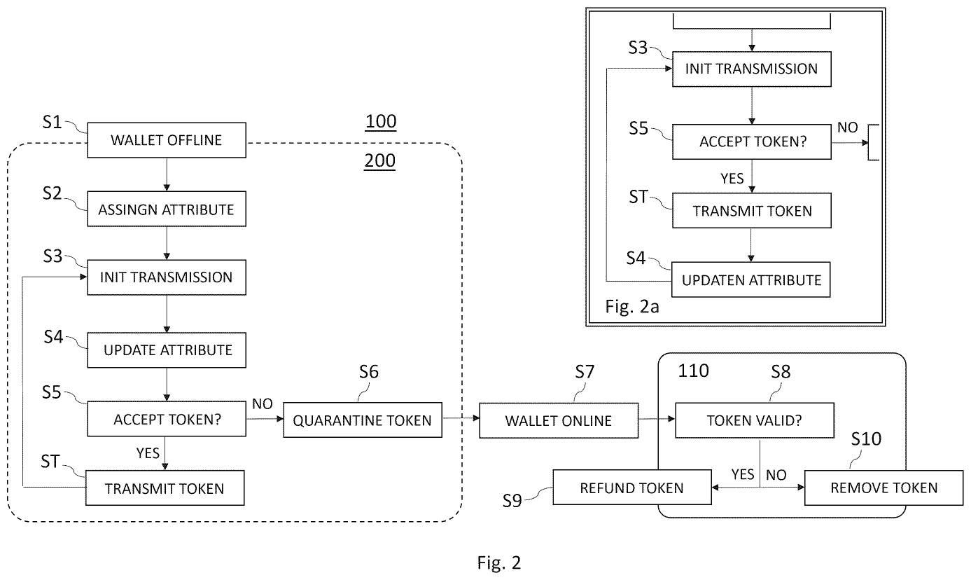

FIG. 2 illustrates in the form of a flowchart the steps of a method for transmitting a digital token between two digital wallets according to the present invention, wherein the attribute is updated by the respective sending wallet before it is transmitted. FIG. 2a illustrates a deviating sequence of steps which is in accordance with the method according to FIG. 1 and in which the updating of the attribute is carried out by the respective receiving wallet after its transmission.

According to a step S1 in FIG. 2, a wallet in which a token is stored goes offline (WALLET OFFLINE). This wallet is disconnected from the transaction infrastructure, for example by switching off a digital end device with a security element in which the wallet is stored or by disconnecting it from the relevant data communication network.

According to a step S2, an attribute A is set up in the token as soon as the relevant wallet is offline (ASSIGN ATTRIBUTE).

According to a step S3, the transmission of the attributed token from a sending wallet to a receiving wallet is initiated (INIT TRANSMISSION).

According to a step S4, the sending wallet updates the attribute A of the token to be transmitted in the manner described above (UPDATE ATTRIBUTE). The development generation of the token that is represented by the attribute is compared with the development generation of the sending wallet and the attribute is assigned the older of these two development generations.

According to a step S5, the receiving wallet performs an acceptance check in the manner described above (ACCPT TOKEN?). The inequality A>(G−T) is checked, where T is a security parameter that determines the oldest development generation that is still acceptable relative to the development generation of the current wallet. If the token was present in a wallet with an older development generation during the current offline session 200, it will not be accepted by the receiving wallet. Of course, the aforementioned inequality is only one of many conceivable acceptance check procedures. It is therefore conceivable that the duration of the offline session 200 is also included in the check (if a trustworthy timer is available) or other parameters, such as a measure of the risk of manipulation of the various development generations or similar.

If the token is accepted in step S5, it is transmitted to the receiving wallet in step ST (TRANSMIT TOKEN) and can be transmitted again by the receiving wallet to other wallets in accordance with step S3.

If the token is not accepted in step S5, the token rejected by the receiving wallet is stored in the sending wallet in step S6 and provided for later validation by an intermediary or another central entity (QUARANTINE TOKEN), which is in contact with the issuer of the tokens or the operator of the wallets and/or the transaction infrastructure.

According to a step S7, the sending wallet with the rejected tokens stored therein goes online again at a certain point in time (WALLET ONLINE) and is then in data communication connection with the intermediary 110 via the transaction infrastructure.

According to a step S8, the token intended for validation is transmitted to the intermediary 110 and validated there (TOKEN VALID?), i.e. it is checked whether the token has actually been forged, manipulated or duplicated.

If this is not the case, i.e. if the token has not been forged and is valid, it is returned to the relevant wallet in a step S9 (REFUND TOKEN) and thus returned to regular circulation. Alternatively, an equivalent replacement token can be issued or the corresponding amount can be settled in another way, for example against a reference account.

However, if the token is a counterfeit, it is withdrawn from circulation in step S10 and destroyed, for example. The token is then tokenized counterfeit money, the value of which may be refunded according to known criteria by providing the wallet in question with an equivalent token.

According to the embodiment variant shown in FIG. 2a, the steps S4, S5 and ST are reversed in their sequence compared to the embodiment variant shown in FIG. 2 such that, according to FIG. 2a, the acceptance check (step S5) takes place first and, if successful, the token is then transmitted (step ST) to the receiving wallet and finally the attribute update (step S4) takes place there. Everything else is identical as described above in connection with FIG. 2. The designations S4 and S5 in FIG. 2a therefore do not imply any temporal or causal sequence.

The sequence of steps according to FIG. 2a corresponds to the embodiment according to FIG. 1, as the acceptance check is first carried out by the receiving wallet, taking into account the (future) attribute A* (step S5), so that the development generation of the sending wallet is taken into account during the check. If successful, the token is transmitted to the receiving wallet (step ST), where its attribute is finally updated.

In the current description of preferred embodiments and variants, the term “token” was used throughout. Of course, this term stands for any number of tokens with possibly very different countervalues. For example, it is possible for tokens to be divisible into any number of values or for tokens to be merged and assume the value sum of the original tokens. Alternatively, indivisible tokens can also be provided, so that each monetary value corresponds to the quantity of a corresponding number of tokens of a smallest value unit.

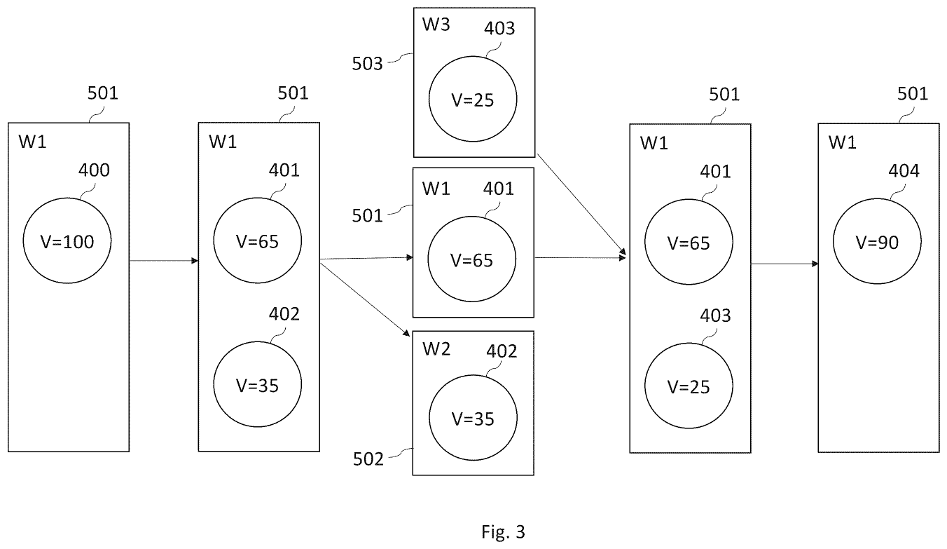

FIG. 3 illustrates the process of dividing or splitting tokens and merging or combining tokens during an offline session. The corresponding teaching and its variants are technically and conceptually compatible with the embodiments according to FIGS. 1 and 2 and can be realized and used within their framework.

The token 400 according to the embodiment according to FIG. 3 is divisible. The token 400 has V=100 currency units. It is stored during an offline session in a wallet 501 with the designation W1 in the following form:

$$dT = ( 100 , A , {G}_{W 1} ) MAC {K}_{W 1}$$

Here
dT denotes the digital token 400,
100 is the value V of the token 400,
A the attribute of the token 400,
G_{W1} the development generation of the wallet W1 in which the token 400 is currently stored or, if applicable, an older development generation if the token has already been transmitted offline,
K_{W1} the cryptographic keys of wallet W1, and
MAC the Message Authentication Code.

The individual Message Authentication Code (MAC) is assigned to each transaction to ensure the integrity of the token transmission between two wallets offline and online. The MAC is generated by a cryptographic algorithm that uses the token, its attribute and a cryptographic key of the sending wallet. The receiving wallet uses a corresponding cryptographic key to verify the MAC, thereby ensuring the authenticity of the token. The MAC is usually based on symmetric encryption, where the encryption key of the sending wallet and the decryption key of the receiving wallet are identical. In a similar way, however, MAC codes can also be used based on asymmetric encryption, in which the sending wallet uses a secret signature key and the receiving wallet uses a corresponding public verification key authenticated by a system certificate.

According to FIG. 3, the starting point is the situation where currency units in the amount of V=35 are to be transmitted to a wallet 502 with the designation W2 in the course of a transaction.

For this purpose, the token 400 is divided into two new tokens 401 and 402, namely dT1 and dT2, which are each stored in the wallet W1 in the following form:

$$\begin{matrix}dT 1 = ( 65 , A , {G}_{W 1} ) MAC {K}_{W 1} \\ dT 2 = ( 35 , A , {G}_{W 2} ) MAC {K}_{W 2}\end{matrix}$$

The shared token 402 with the designation dT2 is then transmitted to the wallet 502 with the designation W2 during the offline session. The transmission process, including the updating and acceptance check of the token 402, has already been described in detail in connection with FIGS. 1 and 2.

After the transmission, the token 402 (dT2) is credited to the wallet 502 (W2), whereby the older of the two development generations G_{W1} and G_{W2} is assigned to the attribute A of the token 402 (dT2) by the wallet 502 (W2) during the update. Token 401 (dT1) remains unchanged in wallet 501 (W1).

In the case of the reverse process of merging the token 401 of wallet W1 with a token 403 of a wallet W3 with the development generation G_{W3} transmitted to wallet W1 to form a new token 404, the two original tokens

$$\begin{matrix}dT 1 = ( 65 , A , {G}_{W 1} ) MAC {K}_{W 1} \\ dT 3 = ( 25 , A , {G}_{W 3} ) MAC {K}_{W 3}\end{matrix}$$

form a new token 404 (dT), which carries the sum of the currency units of dT1 and dT3: dT=(90, A, G_{W3}) MAC K_{W1}

For security reasons, attribute A of the new token 404 (dT) would be assigned the older of the two development generations G_{W1} and G_{W3}, which represent the two attributes A of tokens 401 (dT1) and 403 (dT3). In the example in FIG. 3, the development generations G_{W} of wallet 503 (W3) are older than the development generations G_{W1} of wallet 501 (W1) and are therefore adopted for token 404.

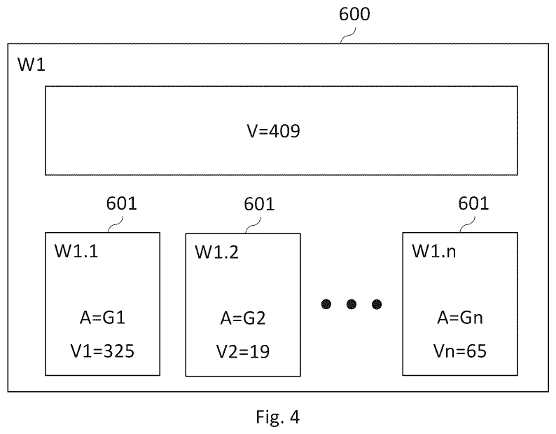

According to a particular embodiment of the invention illustrated in FIG. 4, instead of the token-based approach described so far, an account-based approach can also be pursued, in which transmissions of value units from a sending wallet to a receiving wallet are not realized by the electronic transmission of one or more digital tokens of the desired value, but by the subtraction of the value to be transmitted in the sending wallet and the addition of the value to be transmitted in the receiving wallet.

FIG. 4 illustrates a wallet 600 according to the account-based approach with the designation W1 and the summary account balance V=409 (=V1+V2+Vn). It comprises several sub-wallets 601, in each of which only value units of a certain development generation are recorded. For example, the sub-wallet W1.1 contains value units amounting to V1=325, which were present in an oldest wallet of the development generation G1 during the current offline session. The attribute A=G1 is no longer assigned directly to one or more tokens, but to the sub-wallet and therefore indirectly to the value units V=325 contained therein. The same applies to the other sub-wallets W1.2 to W1.n.

For example, if wallet 600 transmissions value units amounting to 400, the 325 value units of sub-wallet W1.1 of development generation A=G1 plus 10 value units of sub-wallet W1.2 of development generation A=G2 plus the 65 value units of sub-wallet W1.n of development generation A=Gn are transmitted and processed by the receiving wallet in the manner described in connection with FIGS. 1 and 2 and finally booked in the corresponding sub-wallets of the receiving wallet, provided that the update and the acceptance check are successful.

Of course, the acceptance check for a transaction according to the account-based approach can also lead to the acceptance of a partial amount, as with the token-based approach. In the example shown in FIG. 4, for example, this can result in only value units of generations G1 and G2 totaling 335 being accepted and the 65 value units of generation Gn being rejected by the receiving wallet. In the above description, the invention has been described with reference to certain embodiments. However, it will be apparent that various modifications and changes can be made thereto without departing from the broader scope of the invention. For example, the process sequences described above are described with reference to a particular sequence of process actions. However, the order of many of the process steps described may be changed without affecting the scope or operation of the invention. Accordingly, the description and drawings are to be understood as illustrative rather than limiting.

1. A method for transmitting a digital token between digital wallets of a transaction infrastructure during an offline session, the wallets belonging to different development generations, wherein the token is assigned an attribute which represents the development generation of the wallet with the oldest development generation in which the digital token was held at least during the current offline session.

2. The method according to claim 1, wherein the attribute is updated upon transmitting the token and is preferably updated by the wallet receiving the token.

3. The method according to claim 1, wherein, upon successively transmitting the token to a plurality of wallets during the offline session, the respective receiving wallets update the attribute such that the attribute represents the oldest development generation within the plurality of wallets.

4. The method according to claim 2, wherein, upon transmitting the token, the attribute is updated to the development generation of the sending wallet if the development generation represented by the attribute is younger than the development generation of the sending wallet.

5. The method according to claim 1, wherein the attribute of the transmitting token is updated before the receiving wallet accepts the token based on a check of the updated attribute.

6. The method according to claim 1, wherein the receiving wallet accepts the transmitted token based on a comparison of the development generation, which the token represents, with the development generation of the receiving wallet, wherein preferably the token is not accepted by the receiving wallet if the inequality A≤(G−T) is satisfied, where A denotes the development generation represented by the attribute, G denotes the development generation of the receiving wallet and T denotes a predetermined security parameter.

7. The method according to claim 6, wherein tokens not accepted by the receiving wallet are transmitted to an intermediary and/or a to central location for validation and/or renewal after termination of the offline session.

8. The method according to claim 1, wherein the attribute is cryptographically secured, preferably by means of an electronic signature, and/or in that the integrity of the transmission of the digital token is protected by a message authentication code, MAC.

9. The method according to claim 1, wherein the token is indivisible or the token can be fused with other tokens or divided.

10. The method according to claim 1, wherein the attribute is assigned to the token by storing the token in a subwallet of the wallet, the subwallet representing the oldest development generation in which the digital token was held at least during the current offline session.

11. A digital token, configured for transmission between digital wallets of a transaction infrastructure during an offline session, the wallets belonging to different development generations, wherein the token is assigned an attribute which represents the development generation of the wallet with the oldest development generation in which the digital token was held at least during the current offline session.

12. The token according to claim 11, wherein the token is configured to be transmitted during an offline session according to a method during an offline session for transmitting a digital token between digital wallets of a transaction infrastructure during an offline session, the wallets belonging to different development generations, wherein the token is assigned an attribute which represents the development generation of the wallet with the oldest development generation in which the digital token was held at least during the current offline session; wherein the attribute is updated upon transmitting the token and is preferably updated by the wallet receiving the token.

13. A digital wallet of a transaction infrastructure, configured for transmitting digital tokens from or to at least one further digital wallet of the transaction infrastructure during an offline session, wherein the wallet belongs to a development generation and is configured to support a transmission of digital tokens according to claim 11 according to a method for transmitting a digital token between digital wallets of a transaction infrastructure during an offline session, the wallets belonging to different development generations, wherein the token is assigned an attribute which represents the development generation of the wallet with the oldest development generation in which the digital token was held at least during the current offline session.

14. The digital wallet according to claim 13, wherein the wallet is configured to update the attribute of a token transmitted to the wallet to the development generation of the sending wallet if the development generation represented by the attribute is younger than the development generation of the sending wallet.

15. The digital transaction infrastructure comprising a plurality of digital wallets according to claim 13 and digital tokens configured for transmission between digital wallets of a transaction infrastructure during an offline session, the wallets belonging to different development generations, wherein the token is assigned an attribute which represents the development generation of the wallet with the oldest development generation in which the digital token was held at least during the current offline session;
wherein the transaction infrastructure is configured to support offline sessions and preferably comprises a validation unit which validates and/or renews tokens which have not been accepted by wallets during an offline session.
